(19) United States
(12) Patent Application Publication
(10) Pub. No.: US 2018/0086450 A1
(43) Pub. Date: Mar. 29, 2018

(54) AMPHIBIOUS FLYING VEHICLE

(71) Applicant: Young Chan PARK, Hanam-si (KR)

(72) Inventor: Young Chan PARK, Hanam-si (KR)

(21) Appl. No.: 15/276,809

(22) Filed: Sep. 27, 2016

(51) Int. Cl. B64C 37/00; B64D 27/10; B63H 11/02; B64C 33/02; B60F 5/02; B63G 8/08; B63G 8/14

(52) U.S. Cl. CPC B64C 37/00; B64D 27/10; B63H 11/025; B63B 2207/02; B60F 5/02; B63G 8/08; B63G 8/14; B64C 33/025

(57) ABSTRACT

An amphibious flying vehicle, including a vehicle body; a gas turbine engine installed inside of the vehicle body; a hydrogen ion engine installed at a lower portion of the vehicle body; a pair of magic square permanent magnet sets installed at an upper portion of the vehicle body; a pair of electromagnetic coil guns installed at the lower side of the vehicle body; and a pair of front wheel and rear wheel electromagnetic road wheels fixed at the bottom surface of the vehicle body.

### BACKGROUND

The present invention relates to an amphibious flying vehicle, and in particular to an amphibious flying vehicle which is able to operate underwater and fly in the midair in accordance with a driver's control.

As vehicle, ship and airplane industries acrossed the quantum leap excellent a lot of transportations or leisure devices which show great performances are also developed and are commercially available; however such means and devices have the following problems, which are hindering the specialization and popularization of leisure cultures.

The surface of a metallic sphere forming the body of an ordinary vehicle or a submarine is not equipped with a device which is able to create plasma operating as a protection membrane, a device which operates as a conductor using ion seawater as a conductor by creating a high temperature plasma, and a device which is built inside as a part of a vehicle body itself, thus adjusting a buoyancy when it needs to adjust the buoyancy based on the input and output of seawater from the outside.

### SUMMARY

Accordingly, the present invention is directed to providing an amphibious flying vehicle thereof that can vertically take off or land, which is configured in a metallic sphere type and is referred to a gas turbine engine and in which a superconductor magic square permanent magnet rotor is installed at a front portion and a rear portion of a head part of a vehicle body, and a hydrogen ion engine is built inside the propellant of the lower side of the vehicle body.

In addition, the present invention provides an amphibious flying vehicle which is formed hollow in the form of a flexible cane, wherein a vehicle body is able to fly in the midair and submerge or levitation with the aid of upward and downward winging.

In addition, the present invention provides an amphibious flying vehicle wherein a rotation circular plate is installed at a hydrogen ion engine ion beam during an underwater flight, and an electromagnetic rail is installed over the same, and an electromagnetic rudder driving shaft is installed along the electromagnetic rail, and the vehicle body is rotated in the horizontal direction about the seawater below the bottom of the vehicle body, by which the vehicle body is able to rotate 360°, thus underwater flight.

The present invention provides an amphibious flying vehicle, which may include, but is not limited to, a vehicle body 100 which is formed in a metallic spherical shape; a gas turbine engine 101 which is installed inside of the vehicle body 100 and is able to generate a thrust for a forward flying when the vehicle body 100 flies in the midair; a hydrogen ion engine 200 which is installed at a lower portion of the vehicle body 100 and is able to gush out plasma at a high speed using an ion beam in order to be an underwater propulsive unit when the vehicle body 100 sails underwater; a pair of magic square permanent magnet sets 300a and 300b which are installed at an upper portion of the vehicle body 100 and are configured to be cooled by a liquid nitrogen and are able to levitate the vehicle body 100 in the midair and rotate the vehicle body 100; a pair of electromagnetic coil guns 400a and 400b which are installed at the lower side of the vehicle body 100 and are able to generate a propulsive force using a magnetic force which generates using a reaction occurring when an ionized seawater is passed and emitted to the rear side of the vehicle body 100; a pair of front wheel and rear wheel electromagnetic road wheels 500a and 500b which are fixed at the bottom surface of the vehicle body 100 and are used when the vehicle body 100 lands; a pair of flagpole wings 600a and 600b and a pair of feathers 625 and 635 which are formed hollow like a flexible cane and are configured to allow to levitate the vehicle body 100 and maintain the vehicle body 100 in the midair; a self-power generator 700 which is able to generate an electric power using a magnetic field and the flow of the seawater; and an operation and control device 800 which is able to maintain a waterproof function during an underwater flight and allows to carry out a sailing in such a way that a driver's seat lift off during a midair flight.

The amphibious flying vehicle according to the present invention has the following effects.

First, the vehicle body of the amphibious flying vehicle is made in the form of a metallic sphere. When being driven, it uses a gas turbine engine. A superconductor magic square permanent magnet rotor is installed at a front portion and a rear portion of the head part of the vehicle body. The vehicle body is able to vertically take off or land using a propulsion unit wherein a hydrogen ion engine is built inside the propellant of the lower side of the vehicle body.

Moreover, a vision field can be obtained using a telescope during the amphibious flying, and a rotation circular plate is disposed at a hydrogen ion engine ion beam during the underwater flight, and an electromagnetic rail is installed over the same, and an electromagnetic rudder driving shaft is installed along the electromagnetic rail, and the vehicle body is rotated about the seawater below the bottom of the vehicle body, by which the vehicle body can rotate 360° in the horizontal direction, thus underwater flight.

In addition, the left and right flagpole wings can be bent like a flexible cane during the flying in the midair by means of a scotch yoke. If the left and right flagpole wings (including a knife comb-shaped wing and a feather) flap downward, a buoyancy can be created in such a way to form a flexible cane membrane, and if the left and right flagpole wings flap upward, the knife comb-shaped wing and feather become separate from each other and rotate, by which the vehicle body can fly in the midair in the way where the air deflates.

Furthermore, a sight field can be obtained using a telescope during the amphibious flying of the vehicle body. If the vehicle body submerges, an electromagnetic door comes down in a driver protection device shelter, which allows for a blocking based on the use of a double entrance door. The same poles are formed at the bottom electrode of the driver protection device shelter and the upper surface of an electromagnetic injection machine. Since the same poles are repulsive to each other, the driver protection device shelter is able to levitate with the aid of a northcal intake port and separate and escape from the vehicle body.

### BRIEF DESCRIPTION OF THE DRAWINGS

FIG. 1 is a perspective view illustrating the whole appearance of a vehicle body of a metallic sphere configuration of an amphibious flying car according to a preferred embodiment of the present invention;

FIG. 2 is a view for describing an electromagnetic ring wherein plasma generates at the surface of a vehicle body of a metallic sphere configuration of an amphibious flying vehicle according to a preferred embodiment of the present invention;

FIG. 3 is a view for describing a configuration of a hydrogen ion engine which is installed at an amphibious flying vehicle according to a preferred embodiment of the present invention;

FIG. 4A is a view for describing a configuration of a superconductor magic square permanent magnet which is installed at an amphibious flying vehicle according to a preferred embodiment of the present invention;

FIG. 4B is a view for describing a detailed configuration of a superconductor magic square permanent magnet which is installed at an amphibious flying vehicle according to a preferred embodiment of the present invention;

FIGS. 4C and 4D are views for describing a configuration of a cylindrical permanent magnet of a superconductor magic square permanent magnet which is installed at an amphibious flying vehicle according to a preferred embodiment of the present invention;

FIG. 5 is a view for describing a configuration of an electromagnetic coil gun which is installed at an amphibious flying vehicle according to a preferred embodiment of the present invention;

FIGS. 6A and 6B are views for describing the operations of an electromagnetic road wheel, an electromagnetic rail and a rudder which are installed at an amphibious flying vehicle according to a preferred embodiment of the present invention; and

FIGS. 7A and 7B are views for describing the operations when a flagpole wing and a feather ascend and descend, which are installed at an amphibious flying vehicle according to a preferred embodiment of the present invention.

### DETAILED DESCRIPTION

The terms and words used throughout the specification and claims should not be interpreted as having a typical or dictionary meaning, but should be interpreted as having the meaning and concept which match with the technical concept of the present invention based on the principle that any inventor is able to appropriately define the concept of a corresponding term so as to describe his invention in the best way.

Moreover, the embodiments of the specification and configuration illustrated in the drawings are referred only to the preferred embodiments of the present invention, not representing all the technical concepts of the present invention, and they should be interpreted as there might be various equivalents and modifications which can substitute them at the time the present invention is filed.

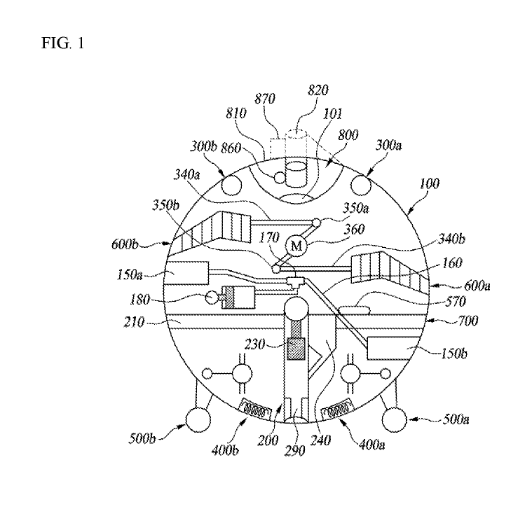

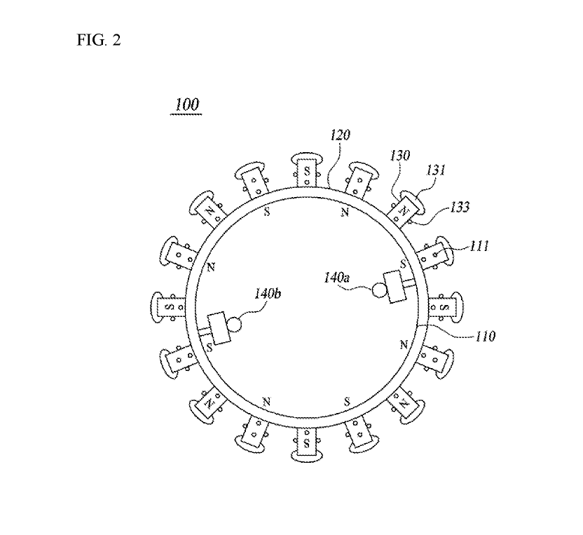

FIG. 1 is a perspective view illustrating the whole appearance of a vehicle body of a metallic sphere configuration of an amphibious flying car according to a preferred embodiment of the present invention, and FIG. 2 is a view for describing an electromagnetic ring wherein plasma generates at the surface of a vehicle body of a metallic sphere configuration of an amphibious flying vehicle according to a preferred embodiment of the present invention.

As illustrated in FIG. 1, the amphibious flying vehicle according to the present invention may include, but is not limited to a vehicle body 100 which is formed in a metallic spherical shape; a gas turbine engine 101 which is installed inside of the vehicle body 100 and is able to generate a thrust for a forward flying when the vehicle body 100 flies in the midair; a hydrogen ion engine 200 which is installed at a lower portion of the vehicle body 100 and is able to gush out plasma at a high speed using an ion beam in order to be an underwater propulsive unit when the vehicle body 100 underwater flight; a pair of magic square permanent magnet sets 300a and 300b which are installed at an upper portion of the vehicle body 100 and are configured to be cooled by a liquid nitrogen and are able to levitate and rotate the vehicle body 100; a pair of electromagnetic coil guns 400a and 400b which are installed at the lower side of the vehicle body 100 and are able to generate a propulsive force using a magnetic force which generates using a reaction occurring when an ionized seawater is passed and emitted to the rear side of the vehicle body 100; a pair of front wheel and rear wheel electromagnetic road wheels 500a and 500b which are fixed at the bottom surface of the vehicle body 100 and are used when the vehicle body 100 lands; and a pair of flagpole wings 600a and 600b and a pair of feathers which are formed hollow like a flexible cane and are configured to allow to maintain a midair flight and horizontality of the vehicle body 100 in such a way that the flagpole wings 600a and 600b and the feathers 625 and 635 upward and downward.

Referring to FIG. 1, a buoyancy adjustment part is provided inside of the vehicle body 100, wherein the buoyancy adjustment part may include a rear top air bladder 150a and a front bottom air bladder 150b which are installed at the stern and bow of the vehicle body 100 in order for a predetermined amount of air to be injected or moved, an air bladder line 160 configured to connect the rear top air bladder 150a and the front bottom air bladder 150b, a check valve 170 configured to selectively adjust the air moving routes of the rear top air bladder 150a and the front bottom air bladder 150b, and a buoyancy adjustment piston 180 configured to adjust the buoyancy in such a way to inflate or deflate the air into/from the rear top air bladder 150a or the front bottom air bladder 150b.

The buoyancy adjustment operations when the vehicle body underwater flight, submerges into the underwater and surfaces over the water will be described below.

In advance, when the underwater flights, the rotational motion of the electric motor is converted into the reciprocation motion of the buoyancy adjustment piston 180, by which the air can be moved to the rear top air bladder 150a or the front bottom air bladder 150b through the air bladder line 160 based on the inclination of the vehicle body 100. In this way, the vehicle body is able to freely underwater move or maintain a horizontal state in such a way to adjust the buoyancy of the vehicle body 100.

When the underwater submerging, the air inside of the front bottom air bladder 150b is deflated by pulling backward the buoyancy adjustment piston 180 with the aid of an electric motor, and the front bottom air bladder 150b is closed by controlling the check valve 170, and in a state where the rear top air bladder 150 has been opened, and the air is injected into the rear bottom air bladder 150a by pushing forward the buoyancy adjustment piston 180, through which the front weight of the vehicle can be heavy, so the vehicle body 100 can be tilted downward and submerge underwater.

On the contrary, in case that the vehicle body surfaces over the water, the buoyancy adjustment piston 180 is pulled backward with the aid of the electric motor, and the air inside of the rear top air bladder 150a is deflated, and the rear top air bladder 150a is closed using the check valve 170, and in a state where the front bottom air bladder 150b has been open, and the air is injected into the front bottom air bladder 150b by pushing forward the buoyancy adjustment piston 180, through which the front weight of the vehicle body 100 can be heavy, so the vehicle body 100 can surface over the water.

The driver is able to adjust the buoyancy in such a way that the air inside of the cylinder is pushed away or deflated through the air bladder line 160 while moving back and forth the buoyancy adjustment piston 180.

Herein, the buoyancy may have a positive buoyancy (levitating on the water), a negative buoyancy (sinking underwater), and a neutral buoyancy (not levitating on the water, nor sinking underwater). The air bladder is able to move by adjusting the viscosity of the vehicle body 100 and matching the viscosity of the vehicle body 100 with the viscosity of the nearby water. The air bladder may be referred to an air pocket made of a thin leather material and provided at the vehicle body 100. It is referred to a device called an air bladder of the vehicle body 100, by which the vehicle body is able to sail underwater, submerge and surface over the water in such a way to adjust the buoyancy thereof. The air bladder may be referred to a buoyancy adjustment device which is able to adjust how deep the vehicle body goes down or how high it goes up or which is configured to inform the balance of the vehicle body. The driver is able to allow the vehicle body to sail into a deep sea by handling the buoyancy adjustment piston 180.

Moreover, when sailing underwater, the vehicle body 100 is able to obtain a sight field using a telescope 820. When the vehicle body submerge, the electromagnetic door comes down in the driver protection device shelter 810, and it is blocked by a double entrance door, and the same poles can be formed at the bottom electrode of the driver protection device shelter 810 and the upper surface of the electromagnetic injection machine 860. In case of emergency, the driver protection device shelter 810 can fly into the midair with the aid of the northcal intake port 870 based on the principle that the same poles are repulsive to each other, thus separating and escaping the vehicle body 100.

Moreover, the vehicle body 100 may include, but is not limited to, a spherical electromagnetic ring fixing shaft 110, a spherical electromagnetic ring 120 fixed at the outer surface of the electromagnetic ring fixing shaft 110, a plurality of protrusions 130 which are formed protruding from the outer surface of the spherical electromagnetic ring 120, wherein oil is coated in a mushroom shape 131 on the top thereof, and a plurality of small holes 133 are formed on the surfaces of the protrusions 130, and a plurality of pistons 140a and 140b installed at the inner surface of the electromagnetic fixing shaft 110.

Compressed liquid nitrogen 111 can be sprayed through the small holes 133 formed at the oil-coated coating surface 131 which is formed a tough and strong waterproof mushroom shape at the top of the protrusion 130 protruding from the surface of the metallic spherical vehicle body 100, and can be rotated by a large electromagnetic ring 120, thus producing the plasma vapor without heating the same like the conventional technology.

In other words, where the liquid nitrogen compressed using the pistons 140a and 140b is being sprayed from the inside of the vehicle body 100 toward the outward direction, the large electromagnetic ring 120 is rotated at a high speed. Meanwhile, the compressed liquid nitrogen is heated, and a high pressure plasma is produced, and a vapor cushion can be created. The plasma can be produced, without being heated, with the aid of the rotational force of the large electromagnetic ring 120 through a plurality of the small holes 133 formed at the mushroom-shaped oil-coated coating surface 131 formed at the tops of a plurality of the protrusions 130 formed protruding from the surface of the metallic spherical vehicle body 100.

This technology may come from the technology wherein water can be boiled without producing bubbles if the surfaces are specially processed in order not to break the vapor cushion which is described in the report by Ivan Vakarelski who is an engineer for the Clean Combustion Research Center of King Abdullah University in Saudi Arabia.

The production procedure of such plasma will be described in detail with reference to FIG. 2.

To compress the liquid nitrogen using the pistons 140a and 140b, the liquid nitrogen is compressed as it is pushed backward into the inside of the mushroom-shaped coil coating surface 131 in a liquid nitrogen raw material container.

For this reason, since the internal pressures of the pistons 140a and 140b increased, the inflow valve of the inflow pipe through which the liquid nitrogen passes is closed, thus blocking the inflow of the liquid nitrogen, and the discharge valve of the discharge pipe is opened, and the liquid nitrogen inside of the cylinder can flow in the outward direction.

Meanwhile, if the pistons 140a and 140b return back to their positions, the internal pressures of the pistons 140a and 140b are lowered, so the opening and closing of the discharge pipe and the inflow pipe may be reversed, for which the liquid nitrogen can flow in again.

If the pistons 140a and 140b are compressed, the internal pressures of the pistons 140a and 140b may be pushed into the inside of the mushroom-shaped oil coating surface 131, by which the liquid nitrogen is compressed. In this way, the pressure of the liquid nitrogen inside of the pistons 140a and 140b may increase, and the liquid nitrogen can be sprayed through the discharge pipe.

Meanwhile, the liquid nitrogen pumped toward the discharge pipe using the pump to be sprayed in the form of small particles like fog, the portion to discharge the liquid nitrogen is formed of a snorkel exhaust hole through which the liquid nitrogen can be sprayed in the form of small particles, by which the liquid nitrogen can be discharged in the form of vapor like fog, more specifically, it can be sprayed in the form of bubble (foam, air bubble). If the snorkel hole having the function of the nozzle is connected to the discharge pipe, since the small holes 133 may interfere with the flow of the liquid nitrogen, the pistons 140a and 140b should push with a large pressure the liquid nitrogen which moves toward the nozzle. If the liquid nitrogen which has been pushed by a high pressure, is sprayed through small size holes, the liquid nitrogen may be divided into parts after it has collided with the seawater, so the liquid nitrogen can become into small particle liquid nitrogen like fog.

Herein, the liquid nitrogen is referred to a liquid which has a large liquidity and is easy to flow. It can rotate along the wall surface for a longer time than the common liquid thanks to the Leidenfrost effect. The Leidenfrost effect means that if a predetermined liquid contacts with a portion which is much hotter than the boiling point of the predetermined liquid, the liquid can quickly start to boil, thus forming an insulation layer formed of vapor. This effect can be easily understood by the occasion wherein water is sprayed on a frypan so as to measure temperature during the cooking.

Since the liquid nitrogen has a smaller molecule size than that of water, it can pass through a thing through which water cannot come in or pass. If the surface is specially processed in order not to break the vapor cushion, water can be boiled without producing bubble. This can be carried out in such a way that the surface is processed to repulse to water. The surface may be covered with the metallic spheres connected with the mushroom-shaped oil-coated surface which form the surface into a tough and strong waterproof, and the liquid nitrogen can be sprayed through the small holes 133, and the super-hydrophobic spheres can be heated using the torque of the large electromagnetic ring 120.

Meanwhile, the liquid nitrogen is a substance produced by liquefying the nitrogen which accounts for 78% of the air. For example, if 2 g of the hydrogen gas burns, 57.72 cal/mo of the calorie generates, so the vapor can expand. If 1 m₃ of the hydrogen gas contacts with air at 0°, it may explode while causing a flame. The solid hydrogen density may be formed like a pillar, and the pillar shape is most efficient, and it may burn evenly through all of the portions constantly.

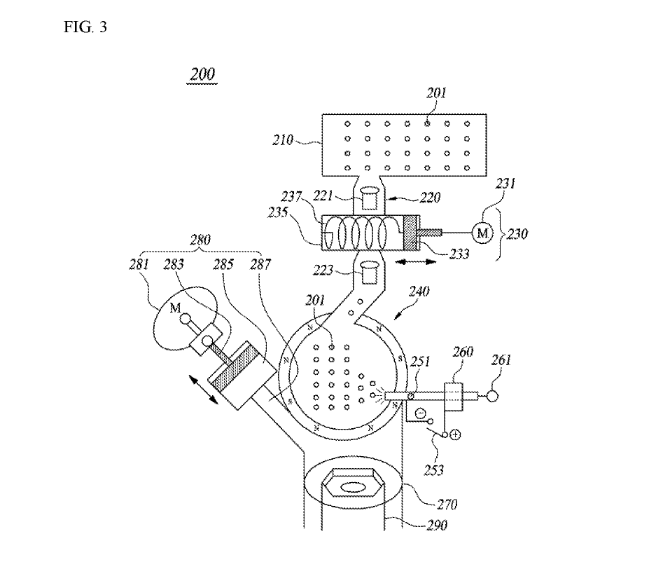

FIG. 3 is a view for describing a configuration of a hydrogen ion engine which is installed at an amphibious flying vehicle according to a preferred embodiment of the present invention.

Referring to FIG. 3, the hydrogen ion engine 200 according to the present invention may include, but is not limited to, a solid hydrogen fuel container 210, a hydrogen emission reactor 220 which is able to emit in a predetermined amount the solid hydrogen 201 discharged from the solid hydrogen fuel container 210, a sprayer type piston 230 which is installed in the middle of the hydrogen emission reactor 220 and is able to control the input or output of the solid fuel by adjusting the internal pressure of the hydrogen emission reactor 220, a combustion chamber 240 configured to combust the solid hydrogen discharged from the hydrogen emission reactor 220, an arc ignitor 250 which is able to ignite an arc on the combustion chamber 240, an oxygen supply nozzle 260 configured to supply the oxygen to the arc ignitor 250, a discharge chamber 270 wherein the solid hydrogen combusted in the combustion chamber 240 carries out an arc discharge which generates a strong light and a high temperature heat, a compressed air supply part 280 which is able to supply the compressed air to the discharge chamber 270, and a hydrogen ion engine ion beam 290 which is employed to spray the plasma which is produced through the arc discharge in the discharge chamber 270.

The solid hydrogen used at the hydrogen ion engine 200 is formed in the shape of a thumb-sized small pill. This is able to form an ammonia borane, which can be continuously supplied to the hydrogen emission reactor.

Meanwhile, the magnesium has a good bonding strength with hydrogen, so it is known that the magnesium can function as a solid storage (a bowl) of hydrogen. The magnesium particle may be split into small parts of nano meter sizes, and this nano powder type magnesium is able to easily receive or discharge hydrogen atoms even when the operational environment of the common hydrogen fuel cell is 200˜300° C. The hydrogen of about 4 kg can be stored in a solid fuel state using the technology.

Referring to FIG. 3, the hydrogen ion engine 200 is referred to an arc rocket type ion propulsion system, wherein a solid hydrogen 201 is inputted into the flame arc 251 formed between the electrodes, and it is heated in the combustion chamber 240 and is accelerated to the nozzle 260 without using the characteristic of the plasma.

According to the preferred embodiment of the present invention, the electric energy is not converted into a heat energy, but is directly converted into a kinetic energy and is used. The hydrogen gas emitted to the hydrogen ion engine ion beam 290 is a plasma state, but it does not use the characteristic of plasma during the acceleration. More specifically, it is similar with the plasma engine, but the principle between them is different. The plasma engine uses a method wherein the gas which will be used as a propulsion agent is produced by an electricity method into the form of plasma, and the plasma is directly accelerated using the electromagnets and is sprayed. The solid hydrogen 201 has a disadvantage in the way that once the rocket using a solid propulsion agent is ignited, the reaction cannot be interrupted. The solid hydrogen, however, can be easily stored and is easy to handle with. As the solid fuel, a metallic aluminum powder and a magnesium powder are widely used.

In the preferred embodiment of the present invention, the hydrogen ion engine 200 is designed to generate a thrust for a moment whenever it needs to, not continuously generating the thrust for a long time, for which a special cooling device is not necessary. This method needs a very small amount of fuel, while reducing any damage to the engine. The solid hydrogen ammonia borane is a while solid hydrogen, and the hydrogen contained in a thumb-sized container is able to generate a high capacity electric power. The solid hydrogen ammonia borane can be formed in the form of a small pill, which can be continuously supplied to the hydrogen emission reactor 220. The solid hydrogen 201 may use the principle of a sprayer type piston 230 when it is injected into the combustion chamber 240. The piston is pushed back inside by the electric motor 231, and the compression spring 237 inside of the cylinder 235 is compressed. In this way, the internal pressure of the pump provided at the cylinder 235 increases, and the inflow valve 221 of the solid hydrogen is closed, and the hydraulic pressure of the solid hydrogen 201 is blocked, and the discharge valve of the solid hydrogen is open, and the solid hydrogen 201 inside of the cylinder 235 may be discharged.

If the piston 233 returns to its position by the compression spring 237, the pressure inside of the pump decreases, so the opening and closing states of the discharge valve 223 and the inflow valve 221 are reversed. As the pressure of the solid hydrogen 201 filled in the pump increases, the solid hydrogen 201 can be sprayed out through the discharge valve 223.

Moreover, since a nozzle having a narrow hole is necessary in order for the solid hydrogen 201 pumped by the pump to be sprayed in the shape of a circular pillar through the discharge valve 223, as illustrated in FIG. 3, the narrow hole may interfere with the flow of the solid hydrogen 201 in a state where the nozzle 260 has been connected to the discharge valve 233, the pump needs to pump with a high pressure to the outside the solid hydrogen 201 which is flowing toward the nozzle 260.

Here, the solid hydrogen which has been pushed by a high pressure, will be sprayed in the outward direction through the narrow hole of the nozzle 260.

The arc ignitor 250 may be formed of an electric power cable through which a direct current voltage flows, and a circuit breaker 253 which is employed to control the switching of the electric power. One end of the cable is connected to the negative terminal (−) of the electric power, and the other end of the cable is connected to the positive terminal (+). In this state, the cable is connected to the tongs or the ground clamp through the circuit breaker 253.

The embodiment of the present invention is referred to a method wherein the heat of the arc flame allows to covert the electric power into arc, thus melting the solid hydrogen 201 using the heat.

According to the embodiment of the present invention, the arc 251 is referred to, for example, an arc discharge phenomenon wherein a flame generates between the electrodes if the two electrodes having appropriate voltages are contacted and separated, and a gas or a metallic vapor is produced, and a large current flows through the electrodes, thus generating a strong light and a high temperature heat. As for the arc, a core wire is covered with a coating agent, and the substance at the portion which causes a discharge during the arc discharge becomes a plasma state. The arc discharge is referred to a high current discharge state, more specifically, an occasion wherein the discharge increases while the gaseous state (plasma) having a high electric conduction is being maintained.

According to the preferred embodiment of the present invention, the hydrogen ion engine 200 which generates a plasma, uses a pill formed of sugar and a potassium nitrate solid hydrogen. The burning of sugar may cause the potassium nitrate to transfer oxygen.

In the preferred embodiment of the present invention, the hydrogen ion engine 200 allows to generate a propulsive force based on the law of conservation of momentum using the ion beam (electric charges, particle or molecules) and is able to accelerate the ions in the direction of electric fields.

The fuel used to generate plasma in the hydrogen ion engine 200 is a solid hydrogen 201. After the hydrogen has injected in a solid state in the combustion chamber 240, as illustrated in FIG. 3, a N+S+N single pole is disposed at an inner wall surface of the solid hydrogen inside of the sealed combustion chamber 240. In this state, the hydrogen gas can easily separate the plasma with the aid of the magnetic field.

According to the preferred embodiment of the present invention, the solid hydrogen fuel is not corrosive, and it does not need to store at a low temperature, and it can remain stored in a state where the solid hydrogen fuel has been filled at the manufacturing stage. Moreover, it does not need a pump, a control tool, a combustion chamber, etc. so the structure thereof is simple, and a propulsive force can be provided for a long time.

The driver is able to control the output in such a way to adjust the combustion amount using the piston 233.

Meanwhile, in a state where the flame has been made at the hydrogen ion engine 200 by an arc discharge, when the solid hydrogen burns starting from under the bottom of the circular pillar fuel container, the driver is able to increase the passage speed of the hydrogen ion so as to obtain a desirable propulsive force by blowing the compressed air into the metallic plate which has small spraying holes, by using the piston 233 of the compressed air supply part 280.

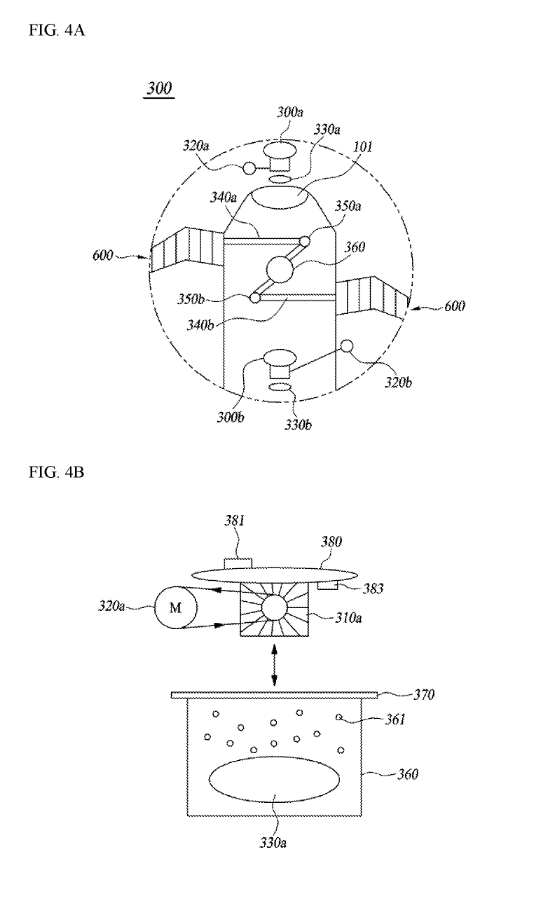

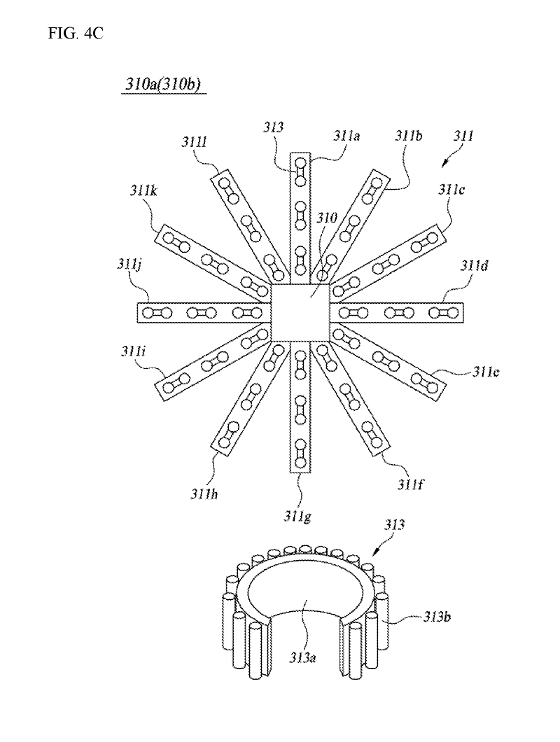

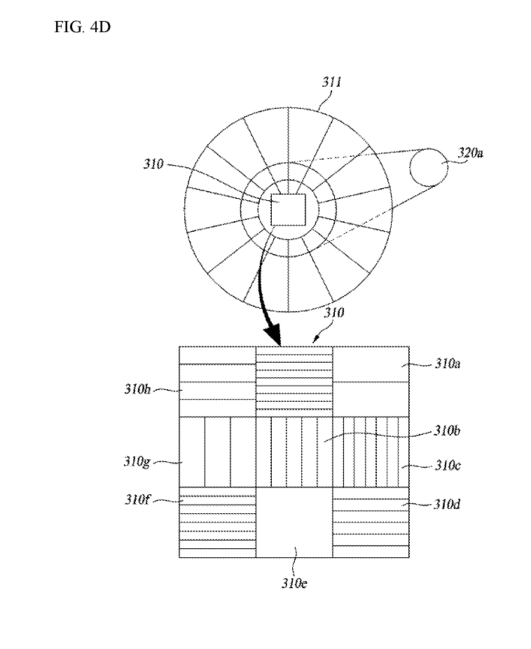

FIG. 4A is a view for describing a configuration of a superconductor magic square permanent magnet which is installed at an amphibious flying vehicle according to a preferred embodiment of the present invention, and FIG. 4B is a view for describing a detailed configuration of a superconductor magic square permanent magnet which is installed at an amphibious flying vehicle according to a preferred embodiment of the present invention, and FIGS. 4C and 4D are views for describing a configuration of a cylindrical permanent magnet of a superconductor magic square permanent magnet which is installed at an amphibious flying vehicle according to a preferred embodiment of the present invention.

Referring to FIG. 4A, the superconductor magic square permanent magnet sets 300a and 300b are installed in the upper, lower, left and right directions at the top of the vehicle body 100, so the number of which is four, and 12 wings of rotary shafts are preferably installed at each of the superconductor magic square permanent magnet sets 300a and 300b.

Referring to FIG. 4B, a liquid nitrogen (below a zero temperature of 190°) is poured on the superconductor 330a filled in the liquid nitrogen container 360, thus cooling the superconductor 330a. If a circular plate under which the magic square permanent magnet 310 is disposed, is placed on the top of the superconductor 330a, the magic square permanent magnet 310 and the superconductor 330a which position under the circular plate 380 become repulsive to each other, by which the circular plate 380 can levitate in the midair.

The scientific principle to levitate the circular plate is similar with the operation wherein a magnetic force is generated when electric power flows. More specifically, if an electric current voltage flows through the superconductor, a magnetic field occurs due to the electric current voltage, and this magnetic field moves around the superconductor. The quantum locking (a superconducting magnet locking) and a flux spinning (a magnetic flux pinning) can be converted into a very strong superconducting magnet using the characteristic of the superconductor. A moving object can be made using the levitating in the midair.

Referring to FIGS. 4A to 4D, the operation wherein the magic square permanent magnet and the superconductor are repulsive to each other, thus obtaining a midair levitating spinning will be described in detail.

Referring to FIG. 4D, the preferred embodiment of the present invention can be implemented with the operation wherein the liquid nitrogen container 360 may position on the top of the superconductor 330a, and a liquid nitrogen (below a zero temperature of 190°) is poured on the superconductor 330a filled in the liquid nitrogen container 360, thus cooling the superconductor 330a. Thereafter, if the circular plate 380 under which the magic square permanent magnet 310a is disposed, is placed on the top of the superconductor 330a, the magic square permanent magnet 310a and the superconductor 330a which are disposed under the circular plate 380 become repulsive to each other, by which the circular 380 can levitate in the midair.

More specifically, the superconductor 330a is inserted in the liquid nitrogen container 360, and a liquid nitrogen container cover 370 or a wooden plate is placed thereon, and the magic square permanent magnet 310a is finally placed thereon. In this state, the liquid nitrogen is poured into the inside of the liquid nitrogen container 360.

Before the superconductor 330a is made by pouring the liquid nitrogen 361, the magnetic force of the magic square permanent magnet 310a penetrates through the superconductor 330a. In a state where the superconductor 330a has been cooled, it may receive the magnetic force from the magic square permanent magnet 310a and become a magnet. The superconductor 330a and the magic square permanent magnet 310 may attract each other and may be repulsive to each other due to a diamagnetism based on the minus effects. The magic square permanent magnet can be manufactured, which is able to spin at a high speed, using the aforementioned principle.

If the superconductor 330a is rotated, a force can be generated based on a strong magnetic levitating force in the direction vertical with respect to the above rotation direction, by which the superconductor 330a can levitate in the midair.

For the sake of the aforementioned midair levitating, the size and intensity of the permanent magnet should be large and strong. The permanent magnet should have a ring shaped symmetrical structure. The circular plate 380 won't spin unless it is a ring-shaped symmetrical type.

According to the preferred embodiment of the present invention, if it needs to manufacture a circular plate under which the magic square permanent magnet is disposed, it is preferred that permanent magnet pieces are first manufactured, and then they are arranged in a circular shape. More specifically, a ring-shaped circular plate is manufactured in such a way to bond a plurality of permanent magnets. In order for the above circular plate to spin over the top of the superconductor 330a, the magnetic forces of the whole magnetic rings should have same poles. If it needs to make a large magnetic levitating force between the superconductor and the permanent magnets, the contact area between them should be wide. Many permanent magnets should be attached to the lower ends of the circular plate, and there should be provided as many as super conductors which will be filled in the cooling container.

Referring to FIG. 4D, according to the preferred embodiment of the present invention, a magnetic line of force to stably levitate the superconductor can be made in such a way that the 12 magic square permanent magnet rotors 311a to 311l of the same poles are arranged crossing in the diagonal directions.

When the vehicle body starts first, the magic square permanent magnets 310: 310a to 310h arranged at regular forms at the bottom the liquid nitrogen container 360 are driven and rotated by the electric motor 320a. In this state, if an electric current is supplied thereto, the magnetic force can be generated by the electric current. This magnetic force may rotate along the magic square permanent magnet 310 by the magnetic force while moving. If the magic square permanent magnet 310 starts to rotate, the magic square permanent magnet 310 can continuously rotate even though the electric power of the electric motor 320a is disconnected.

The electric power may be used to rotate the super conductor 330a. If the superconductor 330a hanging from the top thereof does not work, the electric power of the electric motor 320a is connected to the magic square permanent magnet 310 which position at the lower side of the superconductor, and the superconductor 330a may be cooled using the liquid nitrogen (below a zero temperature of 190°), and if the electric current is supplied, the magnetic force may generate by the electric current. As the magnetic force moves, the superconductor 330a can move together.

The superconductor 330a stuck inside of the permanent magnet ring may levitate over the top of the superconductor ring-shaped permanent magnet. This midair levitating can be made by the minus effect of the superconductor, and if a small force is supplied to the superconductor 330a, the superconductor 330a can rotate. The superconductor 330a is positioned in the center of the permanent magnet ring, and the liquid nitrogen is poured there, and then the superconductor 330a is lifted up, the superconductor 330a can levitate in the midair of an empty space. This phenomenon can be caused by the stripe of a magnetic force which has entered into the inside of the superconductor 330a, not by means of the minus diamagnetic force. At this time, the magnetic force stuck by the superconductor 330a may make a stripe of the magnetic force with the permanent magnet, and the two objects bonded by a strong stripe of the magnetic force does not separate from each other even when an external force is supplied thereto, which may be called a stripe phenomenon of a magnetic force. The aforementioned stripe phenomenon of the magnetic force does not take place at all the superconductors, but the high temperature superconductors of all the oxides including most of the compound superconductors are known as a type-2 superconductor. The superconductor is a diamagnetic substance and is repulsive with respect to a weak magnetic field of the permanent magnet, a midair levitating is possible without a strong magnetic force. For this reason, if the temperature of the liquid nitrogen rises outside the superconductor, the superconductor will stop, and the permanent magnets under the super conductor may rotate by the electric power of the electric motor instead of the super conductor in the direction of the force thereof corresponding thereto, and the electric current is supplied to the superconductor which has cooled by the liquid nitrogen, thus rotating the superconductor.

The key effects of the superconductor can be obtained by a mechanical device in such a way to quickly invert the naturally interactive characteristics, and this anti-gravity effect may be estimated as a subsidiary effect of the theory of general relativity by Albert Einstein, which says that a rotating object may distort the gravity.

Referring to FIG. 4, the superconductor magic square permanent magnet 310 may be configured in such a way that the circular pillar permanent magnet 313b is attached in the form of two layers about the cylindrical permanent magnet 313, which makes a triple layer structure, thus creating an anti-gravity, and the 12 small circular pillar permanent magnets 313b are attached evenly to the surroundings of the cylindrical permanent magnet 313, and they are disposed at the outer sides thereof in the same way, thus forming a triple structure magnet model. If the circular pillar-shaped permanent magnets 313b are rotated by the electric motor, the nearby cylindrical permanent magnets 313 and the 12 circular pillar-shaped permanent magnets 313b rotate together, and an electric power can be generated at the outer most portion, while rotating, and at the same time, the liquid nitrogen is cooled at the superconductor 330a in the liquid nitrogen container 360, so the magic square permanent magnet 310 and the superconductor 330a become repulsive to each other, thus rotating in the midair in a midair levitating state.

Meanwhile, as illustrated in FIG. 4C, the superconductor magic square permanent magnets 310 are arranged in such a way that the sums thereof are same in the horizontal, vertical and diagonal directions by disposing the multiple permanent magnets 315a to 315h in the square shape.

The liquid nitrogen is poured in the right center of the ring-shaped permanent magnets 310, and the plate-shaped superconductor is placed in the center of the permanent magnets. In this state, the midair levitating and rotation can be carried out. If the arrangement of the magnets is not correct, the magnetic levitation cannot be available since the magnetic distribution of the permanent magnet has a constant shape.

The magic square permanent magnet 310 is connected with 12 permanent magnets, and when they form a magnet, the magnetic force distribution can be made, so the superconductor can be stably positioned within the shape.

Meanwhile, if the superconductor is dipped in the liquid nitrogen and is taken out and then is placed near the magnet, the magnet and the superconductor may become repulsive to each other due to the minus effect. This phenomenon may be caused without the supply of the electric power. This phenomenon is called a flux pinning effect. When the superconductor is cooled, the magnet and the superconductor are place closer to each other (not contacting with each other), and they are cooled together. Since a superconductive operation does not occur before they are cooled, the magnetic field of the magnet directly passes through the superconductor. If the temperature is lower than a critical temperature, the magnetic field may be stuck within the superconductor. In this state, the magnetic field and the superconductor may have an attractive force where they are attracted by the captured magnetic network and a repulsive force which occurs due to the minus effect, so the superconductor may levitate at a predetermined distance to each other. The superconductor is dipped in the liquid nitrogen 361 and is cooled, and the cooled superconductor is placed on a neodymium permanent magnet, and the 12 neodymium permanent magnets are arranged with the n-pole and the s-pole crossing each other. If the cooled superconductor is placed on the permanent magnet, it is easy to levitate using the magnets and the ring-shaped magnets which are arranged at a predetermined order.

If the superconductor is out of the range of the critical temperature, the superconductor may lose a superconductive operation and may fall down. When the magnet is lifted up, the superconductor can be lifted up together due to the flux pinning effect. If the diamagnetic substance quickly lowers the temperature thereof, it can become a superconductor, and since the force that the superconductor attracts, is weak, it needs to cool it sufficiently. If the characteristic of the permanent magnet is better, and the distance between the superconductor and the permanent magnet is closer, a higher magnetic levitation force can be obtained.

Referring to FIG. 1, the magic square permanent magnet set 300a of the front superconductor and the magic square permanent magnet set 300b of the rear superconductor rotate in the opposite direction to each other, but the superconductor magic square permanent magnet which operates as a tandem rotor which is one of them is installed inclined so as to create a lift in the upward direction, and since the other one rotates in the opposite direction, the other one is installed inclined in the opposite direction, thus creating a lift in the upward direction.

The magic square permanent magnet 300a of the front superconductor and the magic square permanent magnet 300b of the rear superconductor which are installed at the top of the vehicle body 100, may become a tandem rotor and rotate in the opposite direction to each other so as to offset the torque; however since the rotation directions of the inclined tandem rotors, the flow of the air current is same, so the lower direction may rise by the counteraction.

The two superconductor magic square permanent magnets installed at the top of the vehicle body may be manipulated and operated by the setting of a computer installed at the control chamber 800. It may be matched with the speeds of the two superconductor magic square permanent magnets and may be manipulated to rotate in the clockwise direction or the counterclockwise direction toward the front and rear portions of the top of the vehicle body 100. The liquid nitrogen cooling of the superconductor magic square permanent magnets 300a and 300b and the forward and backward direction manipulation may be available at a high temperature, and if it is cooled, the speed is fast, and if it is a high temperature, it stops. If the speed of the magic square permanent magnet 300a of the front superconductor at the top thereof decrease, the speed of the magic square permanent magnet 300b of the rear superconductor may become faster, by which the air at the rear side can be levitated, thus moving downward, and if the speed of the magic square permanent magnet 300b of the rear superconductor at the top thereof decreases, the speed of the magic square permanent magnet 300a of the front superconductor increases, by which the air at the front side can be levitated, thus moving upward.

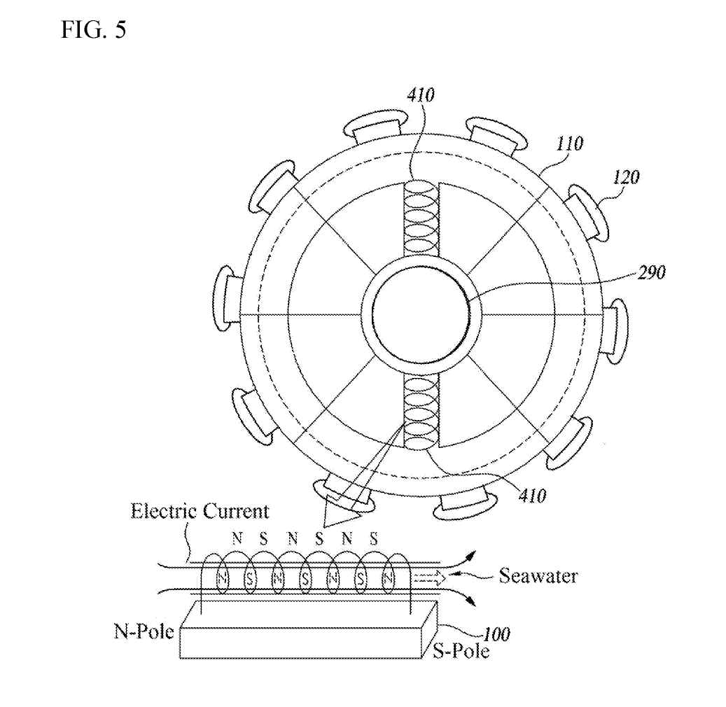

FIG. 5 is a view for describing a configuration of an electromagnetic coil gun which is installed at an amphibious flying vehicle according to a preferred embodiment of the present invention.

Referring to FIG. 5, the seawater heated by a high temperature can be ionized into water (oxygen, hydrogen) and salts in such a way to discharge underwater the plasma by heating and spraying at a high speed the solid hydrogen of the hydrogen ion engine 200. As for the ionized seawater, the electromagnets are disposed, with the n-pole and the s-pole being separated at a predetermined distance, at a pair of the electromagnet coil guns 400a and 400b which are attached at the front and rear portions of the bottom surface of the hydrogen ion engine ion beam 290 at the lower surface of the vehicle body 100. In this state, if the direction of the battery is changed continuously, the ionized seawater (oxygen, anode, s-pole, hydrogen, cathode, n-pole) becomes a conductor, and is arranged to have the same poles as the electromagnetic coil gun, and the electric current is sequentially supplied to the electromagnetic coil guns 400a and 400b, by which the seawater can be accelerated along a set route.

If the electromagnetic coil guns 400a and 400b are attracted by the electromagnetic force, and the direction of the battery is continuously changed, it can be attracted or pushed with the electromagnetic coil suing an electromagnetic force called a seawater. At this time, the seawater passes through an electromagnetic projection device of the strong magnetic field electromagnetic coil guns 400a and 400b and is sprayed backward, and the ionized seawater which has passed through the electromagnetic projection device returns to its original state, and a lift (the force which is applied in the vertical direction with respect to the movement direction when an object moves in liquid) and a propulsive force can be generated by the force that generates when the seawater ions (oxygen, hydrogen and salt) are bonded and its counteraction.

The water molecules have the poles like a magnet having an n-pole and an s-pole. The seawater consists of 96% of water (H₂O) and 4% of salt. If an electric power is supplied to the seawater, the electric power flows between the anode plate of oxygen (O) and the cathode plate of hydrogen (H₂), through which an electrolysis is carried out. If the seawater swivel at a high speed, the seawater may a collision with a number of negative electric charges (anion) formed in the magnetic field (a curtain of force), and the water molecules can rotate fast by the force formed by the magnetic force, and the water molecules are divided into hydrogens and oxygens. Even when the flows of the current are simply changed with respect to the forward and backward movements of the electromagnetic coil guns 400a and 400b, the speed can be easily manipulated by adjusting the intensities of the electric current and the magnetic field. The electromagnetic coil gun is a magnetic engineering system which is able to provide a strong propulsive force by creating the magnetic force, more specifically, it is referred to a device which is able to accelerate the seawater with the aid of the effects by the magnetic field. It may be referred to a projectile which is able to generate a magnetic propulsive force at a high speed by using the electromagnetic coil. The seawater can be accelerated along the route in such a way to sequentially flow the electric current to the coil by using the coil through which the electric current flows so as to form the electromagnetic field. A ring-shaped magnetic field may be formed at a coil through which the electric current flows, and the magnetic field may attract the seawater to one side, and the coil guns use a ferromagnetism of the circular oil. More specifically, these circular coils are arranged long in series in a tunnel shape, and the seawater formed of a ferromagnetism is placed at an end of the tunnel, and the electric current is supplied to the first coil. There is provided a soundless propulsive system equipment by which the vehicle body 100 is able to propel by injecting underwater the ionized seawater to the rear side using the magnetic field coil gun. The vehicle body is able to sail underwater using the magnetic force and energy in a huge amount of liquid called the seawater.

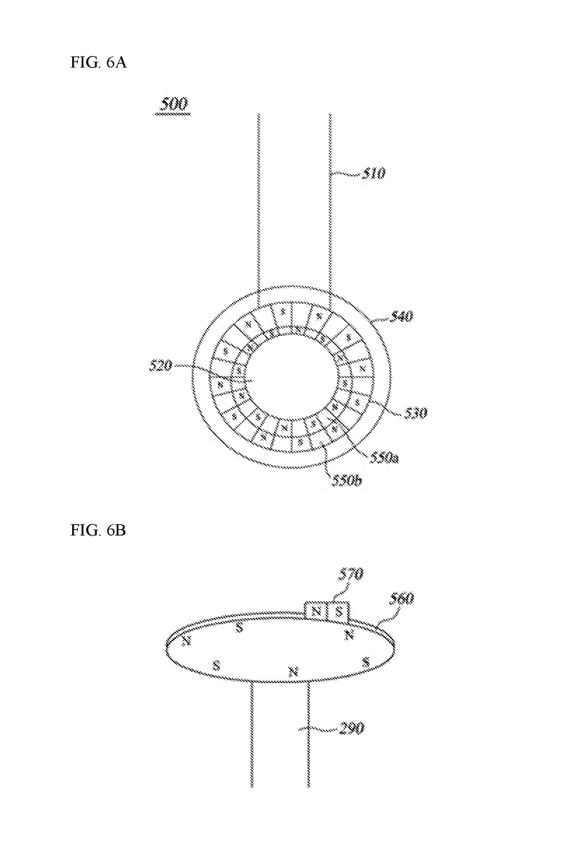

FIGS. 6A and 6B are views for describing the operations of an electromagnetic road wheel, an electromagnetic rail and a rudder which are installed at an amphibious flying vehicle according to a preferred embodiment of the present invention.

Referring to FIG. 6A, the front wheel and rear wheel electromagnetic road wheels 500a and 500b are equipped with an electromagnetic motor and a driving device at the inner side of the electromagnetic road wheel 530. A brake decelerator is installed at the electromagnetic current road wheel 540. Linear motor (a motor which is able to allow a linear motion) electromagnets are disposed at a predetermined interval with an n-pole and an s-pole in the inside of the electromagnetic road wheel 530. The electromagnets 550a and 550b are disposed at a predetermined interval with an n-pole and an s-pole about an electromagnetic road wheel driving shaft 520. They are disposed to have the same pole as the electromagnetic road wheel 530. If the electric current is supplied to the electromagnetic road wheel driving shaft 520, the electromagnetic road wheel 530 may be attracted by an electromagnetic force, and the direction of the battery is continuously changed, and the electromagnetic road wheel driving shaft 520 and the electromagnetic road wheel 530 finally push and attract each other, by which the front wheel and rear wheel electromagnetic road wheels 500a and 500b can rotate, respectively.

The front wheel and rear wheel electromagnetic road wheels 500a and 500b provide small rolling vibrations, and a plurality of electromagnets 550a and 550b are provided inside of the electromagnetic road wheel 530 with the aid of the rotation of the electromagnet without any electric motor, thus flowing the electric current, so the vehicle body can be driven by the magnetic force and can fly in the midair.

According to the preferred embodiment of the present invention, the motor and a suspension (a device configured to support the weight of the vehicle body 100 of a vehicle) are integrated using the electromagnets, for which the necessity of the main engine is reduced, and an empty space can be made where the engine was under a bonnet (a cover configured to cover the space where the engine of the vehicle is disposed), thus reducing the weight of the vehicle body 100.

Referring to FIG. 6B, an electromagnet rail 560 may be installed at the top of the hydrogen ion engine ion beam 290 installed at the lower end of the central shaft of the vehicle body 100. A linear motor (a type wherein the circular coil of a common motor is spread linear) is installed at the electromagnet rail 560. When the electromagnetic rudder 570 mounted at the top of the electromagnetic rail 560 moves, the electromagnetic rudder 570 moves over the top of the electromagnetic rail 560. At this time, if the bottom of the electromagnetic rudder 570 is the n-pole, and the rail which positions below the electromagnetic rudder 570 is the n-pole, may become repulsive to each other, which makes the electromagnetic rudder 570 levitate, and if the front portion is the s-pole, the s-pole of the front portion and the n-pole of the electromagnetic rudder 570 attract each other, so the electromagnetic rudder 570 can move forward. Since the s-pole turns into the n-pole whenever it is repulsive, the electromagnetic rudder 570 is able to keep moving forward.

Meanwhile, the electromagnets 550a and 550b are disposed at the electromagnetic rail 560 with the n-pole and the s-pole being defined at a predetermined interval between them, and the electromagnets 550 and 550b are disposed at the electromagnetic rudder 570 with the n-pole and the s-pole being defined at a predetermined interval between them, so they can be disposed with the same pole as the electromagnetic rail 560. In this state, if the direction of the electric current flowing through the linear motor is continuously switched, the n-pole and the s-pole defined at the electromagnetic rudder 570 can be periodically switched. The attractive force and the repulsive force can be generated alternately and rapidly switching each other between the electromagnetic rail 560 and the electromagnetic rudder 570, through which the electromagnetic rail 560 and the electromagnetic rudder 570 will keep attracting and repulsing. In this way, if the direction of the electric current is inverted, the electromagnetic rudder 570, which has been moving forward, can quickly change its moving direction to the backward direction.

Meanwhile, as the seawater contacts with the bottom of the hydrogen ion engine ion beam 290 during the underwater sailing, the hydrogen ion engine ion beam 290 can be fixed about the seawater, and the vehicle body 100 can rotate 360° along the electromagnetic rail 560 by manipulating the electromagnetic rudder 570.

According to the operation method of the electromagnetic rudder driving shaft, the rotation circular plate is installed at the hydrogen ion engine ion beam 290 during the underwater sailing, and the electromagnetic rail 560 is installed thereon, and the rudder driving shaft is installed at the electromagnetic rail. In this state, the bottom surface of the vehicle body 100 contacts with the seawater, and the electromagnets 550a and 550b are disposed, with the n-pole and the s-pole being defined at a predetermined interval between them, about the hydrogen ion engine ion beam 290 and the electromagnetic rail 560 which are defined as a fixing axis, and the electromagnets 550a and 550b are disposed, with the n-pole and the s-pole being defined at a predetermined interval between them, about the electromagnetic rudder driving shaft 520, so they can be disposed to have the same pole as the electromagnetic rail 560. In this state, if the electric current is supplied to the electromagnetic rudder 570, the electromagnetic rail 560 can be attracted by the electromagnetic force, which makes the directions of the batteries be continuously switched. In this way, the electromagnetic rudder 570 and the electromagnetic rail 560 can attract and repulse each other, by which the electromagnetic rudder 570 can rotate.

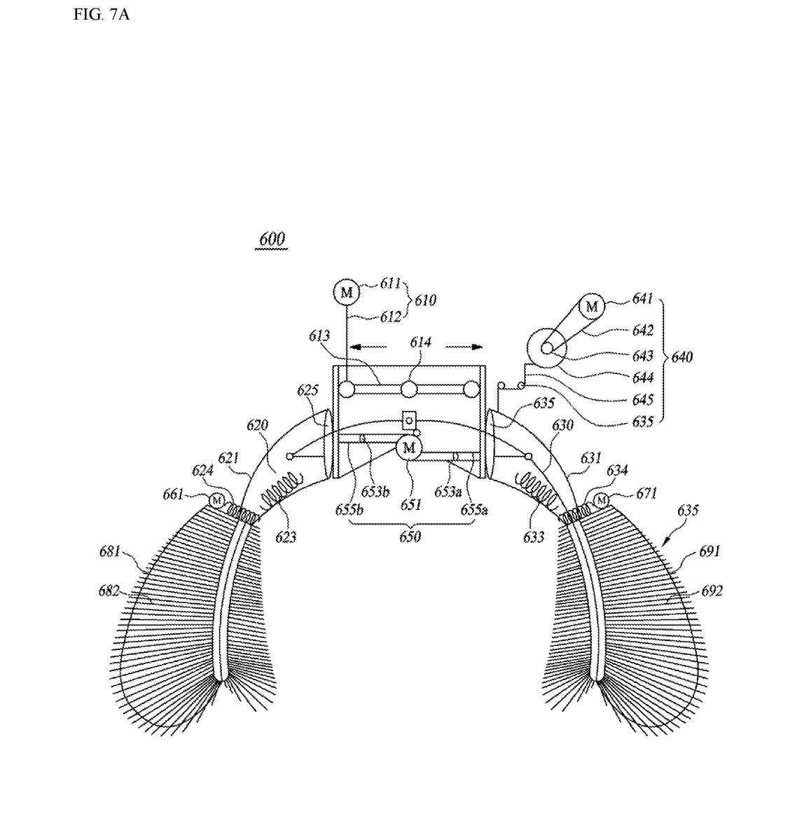

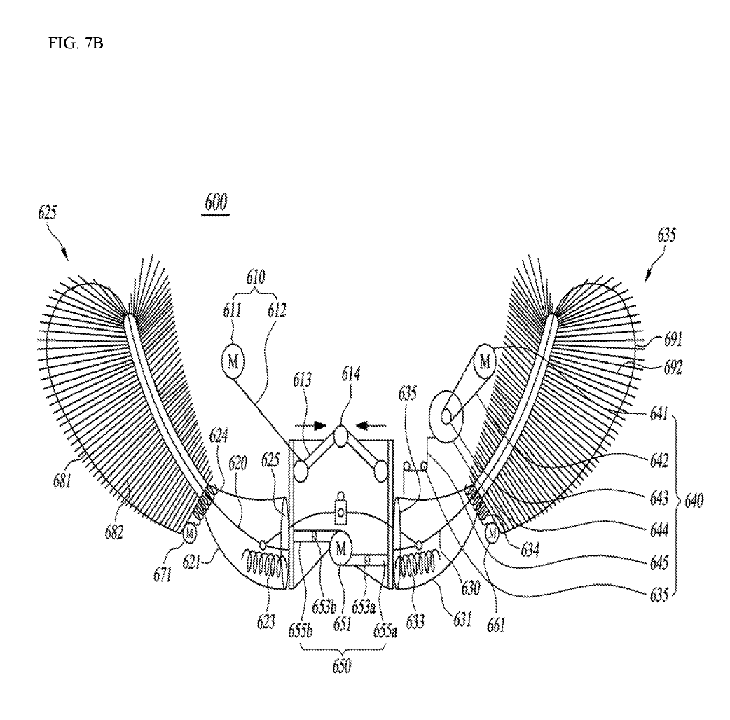

FIGS. 7A and 7B are views for describing the operations when a flagpole wing and a feather ascend and descend, which are installed at an amphibious flying vehicle according to a preferred embodiment of the present invention.

Referring to FIGS. 7A and 7B, the inner side of each of the knife comb-shaped wings 620 and 630 are connected to the cable 612, the rocker arm 613 and the crank shaft 614, and if the cable 612 is wound by the electric motor 611, each of the knife comb-shaped wings 620 and 630 is folded inward, and the knife comb-shaped wings 620 and 630 are bent upward, and if the cable 612 is unwound by the electric motor 611, the knife comb-shaped wings 620 and 630 are unfolded outward, and the knife comb-shaped wings 620 and 630 are bent downward.

The flagpole wing is referred to the whole wing sets including the knife comb-shaped wings 620 and 630 and the feathers 625 and 635. The feathers 625 and 635 are connected through the springs 624 and 634 to the ends of the knife comb-shaped wings 620 and 630. Moreover, the flagpole wing is formed of a small motor, cables 681 and 691 and cane membranes 682 and 692. If the cables 681 and 691 are wound by the small motor, the hollow cane membranes 682 and 692 formed of joints at the feathers 625 and 635 are folded about the vehicle body 100 and are accommodated in place, and if the cables 681 and 691 are unwound by the small motor, the hollow cane membranes 682 and 692 formed of the joints at the feathers 625 and 635 are unfold toward the outside of the vehicle body 100, by which the vehicle body can fly in the midair.

As for the knife comb-shaped wings 620 and 630, the rotational motions thereof are converted into the upward and downward reciprocation motions by means of the scotch yoke 640. As the electric motor 641 rotates in one direction, the knife comb-shaped wings 620 and 630 may reciprocate upward and downward, and the knife comb-shaped wings 620 and 630 may rotate 180°, and the knife comb-shaped wings 620 and 630 can flap from downward to upward and from upward to downward.

The scotch yoke 640 may be disposed at the left and right sides of the knife comb-shaped wings 620 and 630 during the flying in the midair.

The scotch yoke 640 is a kind of the double slide crank devices and is able to convert the rotational motion into the reciprocating motion or the reciprocating motion into the rotational motion. It may include, but is not limited to, an electric motor 641, a belt 642, a driving shaft 643, a piston circular plate 644, a rocker arm 645, and a crank shaft 646. If the electric motor 641 is driven by a half-piston motion wherein the wing of one side rotates, the piston circular plate 644 can be rotated by the driving shaft 643 through the belt 642, and consequently, the rotational motion of the electric motor 641 is converted into the upward and downward reciprocating motion.

As for the feathers 625 and 635 made of the hollow wings which can be bend like a flexible cane wherein the knife comb-shaped wings 620 and 630 move over time, the pulley and the cable are connected, and the knife comb-shaped wings 620 and 630 are able to maximize the buoyancy in such a way that the cable 612 is unwound by the electric motor 611, and the air is blocked by closing the cells of the feathers 625 and 635, so the feathers 625 and 635 form the membranes, and if the knife comb-shaped wings 620 and 630 flap upward, the knife comb-shaped wings 620 and 630 are able to flap, wherein the air flows through between the feathers 625 and 635 as the cable 612 is wound by the electric motor 611, and the gaps between the cells of the feathers 625 and 635 are widened, and they rotate.

In terms of the range to control the knife comb-shaped wings 620 and 630 and the speed, the expandability is very good, which is referred to the technology to control the special wing flapping which may occur when the knife comb-shaped wings 620 and 630 flap upward and downward.

The typical wings make a lot of noise since they generate a vortex and a whirlwind; however the operations of the flagpole wings according to the embodiment of the present invention are carried out by the electric motor 611, so thus much less noise.

For example, if the amphibious flying vehicle submerges, the feathers 625 and 635 operate as a fish fin, and if the knife comb-shaped wings 620 and 630 flap upward and downward, the cable 612 is wound by the electric motor 611 inside which the knife comb-shaped wings 620 and 630 are installed, and the feathers 625 and 635 which operate like the fish fin are folded toward the center of the vehicle body 100, and the knife comb-shaped wings 620 and 630 are bent upward, and the cables 681 and 691 are wound by the small motors 661 and 671, and the gaps between the feathers 625 and 635 are widened and they rotate, and water flows between the feathers 625 and 635, so it can function like a fish fin, by which the vehicle body can sail underwater, and if the knife comb-shaped wings 620 and 630 flap downward, the knife comb-shaped wings 620 and 630 are able to generate the buoyancy in such a way that the cable 612 is unwound by the electric motor 611, and the feathers 625 and 635 are spread to the outside of the vehicle body 100, and the knife comb-shaped wings 620 and 630 are bent downward, and the cables 681 and 691 are finally wound by the small motors 661 and 671, and the feathers 625 and 635 form the cane membranes 682 and 692, by which the vehicle body 100 can submergence flight.

Meanwhile, the features of the knife comb-shaped wings 620 and 630 are the stiff knife comb-shaped configuration which is defined along the front sides of the wings. Each of the knife comb-shaped wings 620 and 630 is formed of a plurality of cells, and since the knife comb-shaped wings 620 and 630 are important components which are necessary for the flight, it is preferred that the knife comb-shaped wings 620 and 630 are made of flexible thin shells. The balance during the flapping of the wings may be lost due to the characteristic of the flagpole wings which move during the midair flying with the aid of only the knife comb-shaped wings 620 and 630 even though their actions are symmetrical, for which a superconductor magic square permanent magnet set 300a is installed at the front side of the top of the vehicle body 100 for the sake of a stable control of the flying operation, and a superconductor magic square permanent magnet set 300b is installed at the rear side of the top of the vehicle body 100, thus maintaining a balance during the midair flying.

In case of the knife comb-shaped wings 620 and 630 according to the present invention, a part of the flagpole wing is equipped with a knife comb for the sake of a resistance which occurs when the knife comb-shaped wings 620 and 630 flap upward and downward while obtaining a lift, and an electric current is supplied to the electric motor 651 connected to the knife comb, so a propulsive force which is over the resistance, can be obtained as the knife comb-shaped wings 620 and 630 and the feathers 625 and 635 flap upward and downward.

Moreover, the knife comb-shaped wings 620 and 630 are made of hollow aluminum and don't make any noise when flapping, and are covered with the feathers 625 and 635, wherein the ends of the knife comb-shaped wings 620 and 630 are cut into parts like a comb. The feathers 625 and 635 are formed of fine hair like a carpet hair, which has a cushioning function to distribute a friction force when contacting with the air. The knife combs of the knife comb-shaped wings 620 and 630 have cut portions like the comb, the gaps between the cells of the feathers 625 and 635 are widened, and they rotate, which allow the air contacting with the knife comb-shaped wings 620 and 630 to easily pass, thus minimizing the generation of the friction sound, so the vehicle body can fly, while causing less sound.

Moreover, the hollow aluminum flagpoles of the knife comb-shaped wings 620 and 630 don't have food flexibility, but are light to stabilize the motions of the wings, thus providing a better flight, and the insides of the flagpoles are hollow.

The horizontal axis which can be defined when the knife comb-shaped wings 620 and 630 move leftward and rightward, may allow to generate a propulsive force, and the electric motor 651 is installed at the rotation circular plate in the center which is engaged at the knife comb-shaped wings 620 and 630. The knife comb-shaped wings 620 and 630 protrude from the inside of the left side of the vehicle body 100 to the outside during the operation, and are accommodated in the inside thereof and are stored in place. Here, the moving operation made with a simple flapping action can be obtained with the aid of the elasticity obtained by attaching the springs 623 and 633 to the lower ends of the knife comb-shaped wings 620 and 630 and the springs 624 and 634 to the feathers 625 and 635 connected to the ends which are covering the knife comb-shaped wings 620 and 630. The vehicle body can move slowly based on the propulsion unit which is able to rotate left and right with the aid of the knife comb-shaped wings 620 and 630, and noise can be reduced.

The amphibious flying vehicle according to the present invention which has been described so far, is referred to the original technology which is characterized in that the electric motor rotates in one direction by the scotch yoke, and the rotational motion is converted into the upward and downward reciprocating motion, and the features thereof are that the shafts of the hollow flagpole wings 600a and 600b which are bent like a flexible cane, the knife comb-shaped wings 620 and 630 and the feathers 625 and 635 are installed at the left and right sides, and when flapping downward, the cane membranes 682 and 692 are formed, thus creating a buoyancy, and when flapping upward, the gaps between the shafts of the flagpole wings 600a and 600b, the knife comb-shaped wings 620 and 630 and the feathers 625 and 635 are widened, and they rotate, thus causing a wing flapping by which the air flows to the outside, thus obtaining a midair flight. Each of the flagpole wings 600a and 600b is referred to a wing set which is formed of the knife comb-shaped wings 620 and 630 and the feathers 625 and 635 covering the knife comb-shaped wings 620 and 630. A mushroom-shaped oil coating is formed on the metallic spherical surface of the vehicle body 100, and plasma is generated by spraying at a high speed the compressed liquid nitrogen of the piston through the fine holes, and the plasma is gushed out at a high speed with the ion beam of the hydrogen ion engine 200, and the ionized seawater is projected to the rear side using the electromagnetic coil gun, so the vehicle body can sail underwater. If the present invention is commercialized, it can be first used for the military purpose. Since the technology of the present invention has never been commercialized yet throughout the world, the field of the present invention is referred to a super power potential market field where the present invention is able to first occupy the market shares with the aid of the differentiated features. The present invention is referred to a new water leisure sport wherein the vehicle body is able to sail underwater and is able to freely fly over the water. In recent years, the demand for a personal helicopter and yacht is increasing from the wealthy class.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. An amphibious flying vehicle, comprising:
a vehicle body 100 which is formed in a metallic spherical shape;
a gas turbine engine 101 which is installed inside of the vehicle body 100 and is able to generate a thrust for a forward flying when the vehicle body 100 flies in the midair;
a hydrogen ion engine 200 which is installed at a lower portion of the vehicle body 100 and is able to gush out plasma at a high speed using an ion beam in order to be an underwater propulsive unit when the vehicle body 100 sails underwater;
a pair of magic square permanent magnet sets 300a and 300b which are installed at an upper portion of the vehicle body 100 and are configured to be cooled by a liquid nitrogen and are able to levitate the vehicle body 100 in the midair and rotate the vehicle body 100;
a pair of electromagnetic coil guns 400a and 400b which are installed at the lower side of the vehicle body 100 and are able to generate a propulsive force using a magnetic force which generates using a reaction occurring when an ionized seawater is passed and emitted to the rear side of the vehicle body 100;
a pair of front wheel and rear wheel electromagnetic road wheels 500a and 500b which are fixed at the bottom surface of the vehicle body 100 and are used when the vehicle body 100 lands; and
a pair of flagpole wings 600a and 600b which are formed hollow like a flexible cane and are configured to allow to levitate the vehicle body 100 and maintain the vehicle body 100 in the midair in such a way that the flagpole wings 600a and 600b flap upward and downward.

2. The vehicle of claim 1, wherein the vehicle body 100 includes:
a spherical electromagnetic ring fixing shaft 110;
a spherical electromagnetic ring 120 which is fixed at the outer surface of the electromagnetic ring fixing shaft 110;
a plurality of protrusions 130 which are formed protruding to the outside from the outer surface of the spherical electromagnetic ring 120, wherein an oil is coated in a mushroom shape 131 on the tops thereof, and a plurality of fine holes 133 are formed at the surfaces thereof; and
a plurality of pistons 140a and 140b which are installed at the inner side surface of the electromagnetic ring fixing shaft 110.

3. The vehicle of claim 1, wherein when the amphibious flying vehicle flies in the midair, each of the flagpole wings 600a and 600b is referred to a wing set which is formed of knife comb-shaped wings 620 and 630 and feathers 625 and 635 covering the knife comb-shaped wings 620 and 630; and each of the flagpole wings 600a and 600b can be bent like a flexible cane since a first electric motor 611 rotates in one direction by a scotch yoke 640 installed inside thereof, and the rotational motion is converted into an upward and downward reciprocating motion; and in case of flapping operations, when each of the flagpole wings 600a and 600b and each of the feathers 625 and 635 flaps downward, cane membranes 682 and 692 are formed, thus creating a buoyancy, and when each of the flagpole wings 600a and 600b flaps upward, the gaps between the flagpole wings 600a and 600b and the feathers 625 and 635 are widened, and they rotate, so the air flows out.

4. The vehicle of claim 3, wherein when the amphibious flying vehicle submerges, and the knife comb-shaped wings 620 and 630 flap upward, a cable 612 is wound by the first electric motor 611 in case of the knife comb-shaped wings 620 and 630, and the feathers 625 and 635 which function as a fish fin, are folded toward the center of the vehicle body 100, and the knife comb-shaped wings 620 and 630 are bent upward, and cables 681 and 691 are wound by second electric motors 661 and 671, and the gaps between the feathers 625 and 635 are widened, so water can flow out between the feathers 625 and 635, thus carrying out the function of a fish fin, and when the knife comb-shaped wings 620 and 630 flap downward, the cable 612 is unwound by the first electric motor 611 in case of the knife comb-shaped wings 620 and 630, and the feathers 625 and 635 are spread in the outward direction of the vehicle body 100, and the knife comb-shaped wings 620 and 630 are bent downward, and the cables 681 and 691 are unwound by the second electric motors 661 and 671, and the feathers 625 and 635 form cane membranes 682 and 692, thus creating a buoyancy, by which the vehicle body 100 can submerge.

5. The vehicle of claim 1, wherein the vehicle body 100 can levitate in the midair based on a principle wherein a superconductor magic square permanent magnet set 300a is installed at a front portion of the top of the vehicle body 100; and in a state where a liquid nitrogen container 360 is positioned at the top of the superconductor magic square permanent magnet set 330a, after the superconductor magic square permanent magnet set 330a is cooled by pouring a liquid nitrogen on the superconductor magic square permanent magnet set 330a filled in the liquid nitrogen container 360, a circular plate 380 under which a magic square permanent magnet 310a is disposed, is placed on the top of the superconductor magic square permanent magnet set 330a, so the magic square permanent magnet 310a disposed under the circular plate 380 and the superconductor magic square permanent magnet set 330a become repulsive to each other, thus levitating the circular plate 380 in the midair.

6. The vehicle of claim 1, wherein the hydrogen ion engine 200 comprises:
a hydrogen emission reactor 220 which is configured to discharge, by a predetermined amount, a solid hydrogen which is discharged from a solid hydrogen fuel container 210;
a sprayer type piston 230 which is installed at an intermediate portion of the hydrogen emission reactor 220 and is able to control the inflow or discharge of the solid fuel by adjusting the internal pressure of the hydrogen emission reactor 220;
a combustion chamber 240 which is able to combust the solid hydrogen discharged from the hydrogen emission reactor 220;
an arc ignitor 250 which is able to ignite an arc on the combustion chamber 240;
an oxygen supply nozzle 260 which is configured to supply oxygen to the arc ignitor;
a discharge chamber 270 configured to cause an arc discharge, wherein the solid hydrogen combusted in the combustion chamber 240 generates a strong light and a high temperature heat;
a compressed air supply part 280 configured to supply the compressed air to the discharge chamber 270; and
a hydrogen ion engine ion beam 290 which is configured to spray the plasma which is generated through an arc discharge in the discharge chamber 270.

7. The vehicle of claim 1, further comprising a buoyancy adjustment part which includes:
a rear top air bladder 150a and a front bottom air bladder 150b which are installed at a stern and a bow of the vehicle body 100 in the inside of the vehicle body 100 in order for a predetermined amount of air to be injected or move;
an air bladder line 160 which is configured to connect the rear top air bladder 150a and the front bottom air bladder 150b;
a check valve 170 which is able to selectively control an air passage route of the rear top air bladder 150a and the front bottom air bladder 150b; and
a buoyancy adjustment piston 180 which is able to adjust the buoyancy by supplying or eliminating the air to/from the rear top air bladder 150a and the front bottom air bladder 150b.
